(19) United States
(12) Patent Application Publication
(10) Pub. No.: US 2019/0282334 A1
(43) Pub. Date: Sep. 19, 2019

(54) INVISIBLE PLASTIC TEETH BRACE FOR ORTHODONTICS

(71) Applicant: ARIX CNC MACHINES CO., LTD., Tainan City (TW)

(72) Inventor: Yi-Chen Yang, Tainan City (TW)

(21) Appl. No.: 15/923,301

(22) Filed: Mar. 16, 2018

(51) Int. Cl. A61C 7/08

(52) U.S. Cl. CPC A61C 7/08

(57) ABSTRACT

An invisible plastic teeth brace for orthodontics is disclosed herein. It mainly comprises a first side wall, a second side wall opposite to the first side wall, a dental crown upper wall for connecting upper edges of the first side wall and the second side wall, and an orthodontic groove jointly defined by the first side wall, the second side wall and the dental crown upper wall. At least one of the dental crown upper wall, a first part connecting the dental crown upper wall to the first side wall, and a second part connecting the dental crown upper wall to the second side wall has at least one hole or has a thickness less than a thickness of the first side wall and the second side wall.

### BACKGROUND OF THE INVENTION

### 1. Field of the Invention

The present invention relates to provide an invisible plastic teeth brace for orthodontics, which comprises a dental crown upper wall having a thickness less than that of two side walls or having at least one hole so as to prevent dental pain and discomfort caused by biting and chewing food.

### 2. Description of Related Art

Irregularly arranged teeth would affect people's oral health, chewing function, and their facial contours. A traditional orthodontic appliance mainly comprises plural brackets to affix on an outside or an inside of the teeth, and a steel wire going through the plural brackets to exert a tractive force upon the teeth. Although the traditional orthodontic appliance can pull the teeth to the correct position and achieve orthodontic effect, it still has many drawbacks, e.g. lack of aesthetics, easy scratching the patient's mouth, gums, and the like. In addition, patients cannot remove the traditional orthodontic appliance from the teeth by themselves to clean, which may cause hygienic problems.

Accordingly, an orthodontic appliance having an invisible plastic teeth brace (3) is developed as showed in FIG. 4. The invisible plastic teeth brace (3) of a prior art is a U-shaped body having an orthodontic groove (31) which is integrally formed by a transparent plastic sheet undergoing a hot press shaping on an orthodontic tooth mold, so the thickness of all parts of the teeth brace is the same. When a user wear the invisible plastic teeth brace (3) on the dental crowns (21) of the teeth (2), the predetermined dentition shape of the orthodontic groove (31) of the invisible plastic teeth brace (3) corrects the teeth position. The invisible plastic teeth brace (3) has transparency and aesthetics and can prevent scratching user's mouth, gums and the like. Furthermore, the invisible plastic teeth brace (3) can be detached from the teeth by the user to clean, which effectively solves the problems of the traditional orthodontic appliance. However, the existing invisible plastic teeth brace (3) having the same thickness of its all parts is worn and covered on the entire dental crowns (21) of the teeth (2). In such a case, the user usually feels dental pain and discomfort when biting and chewing the food due to the invisible plastic teeth brace (3) covered on the dental crowns (21) subject to an occlusal pressure and further pushing the teeth (2).

### SUMMARY OF THE INVENTION

In view of the above-mentioned problems, the object of the present invention is to provide an invisible plastic teeth brace for orthodontics which comprises a dental crown upper wall having a thickness less than that of a first side wall and a second side wall so as to prevent dental pain and discomfort caused by biting and chewing food.

Disclosed herein is an invisible plastic teeth brace for orthodontics. It mainly comprises a first side wall; a second side wall opposite to the first side wall; a dental crown upper wall for integrally connecting upper edges of the first side wall and the second side wall, wherein at least one of the dental crown upper wall, a first part connecting the dental crown upper wall to the first side wall, and a second part connecting the dental crown upper wall to the second side wall has a thickness less than a thickness of the first side wall and the second side wall; and an orthodontic groove jointly defined by the first side wall, the second side wall and the dental crown upper wall.

According to an embodiment of the present invention, the dental crown upper wall is further provided with at least one hole for communicating with the orthodontic groove.

According to an embodiment of the present invention, at least one of a first part connecting the dental crown upper wall to the first side wall and a second part connecting the dental crown upper wall to the second side wall is provided with at least one hole for communicating with the orthodontic groove.

Disclosed herein is also an invisible plastic teeth brace for orthodontics, comprising: a first side wall; a second side wall opposite to the first side wall; a dental crown upper wall for integrally connecting upper edges of the first side wall and the second side wall, wherein at least one of the dental crown upper wall, a first part connecting the dental crown upper wall to the first side wall, and a second part connecting the dental crown upper wall to the second side wall has at least one hole; and an orthodontic groove jointly defined by the first side wall, the second side wall and the dental crown upper wall and communicating with the at least one hole.

Accordingly, when a patient wears the invisible plastic teeth braces of the present invention to bite and chew the food, the present invention can effectively prevent dental pain and discomfort caused by the parts connecting the dental crown upper wall to the two side walls subject to an occlusal pressure so as further to push the teeth.

### BRIEF DESCRIPTION OF THE DRAWINGS

FIG. 1 is a stereogram showing an invisible plastic teeth brace for orthodontics according to the present invention;

FIG. 2 is a cross-sectional view of a first embodiment showing an invisible plastic teeth brace for orthodontics according to the present invention;

FIG. 3 is a cross-sectional view of a second embodiment showing an invisible plastic teeth brace for orthodontics according to the present invention;

FIG. 4 is a cross-sectional view of a prior art.

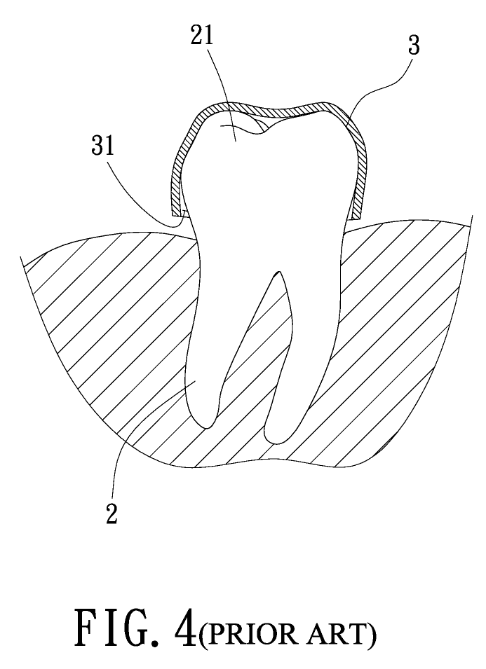

### DETAILED DESCRIPTION OF THE PREFERRED EMBODIMENT

Hereinafter, an exemplary embodiment of the present invention will be described in detail with reference to the accompanying drawings.

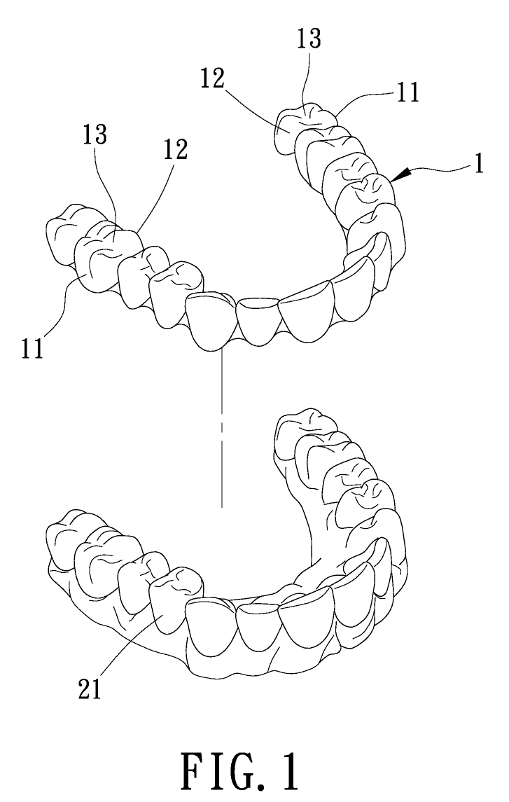

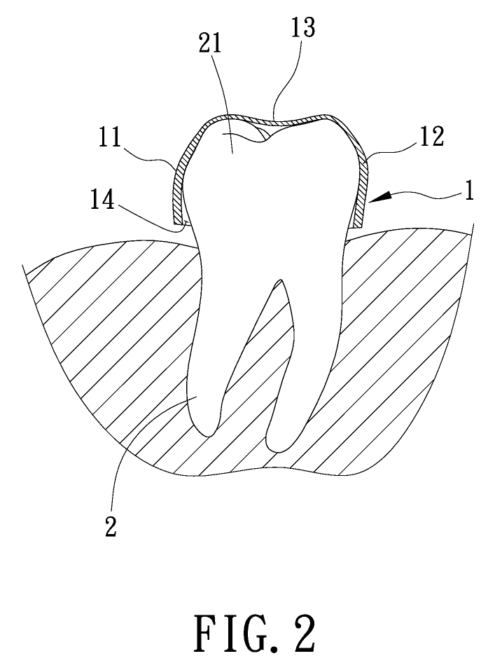

As showed in FIG. 1 and FIG. 2, an invisible plastic teeth brace (1) for orthodontics according to the present invention is disclosed herein. It mainly comprises a first side wall (11); a second side wall (12) opposite to the first side wall (11); a dental crown upper wall (13) for integrally connecting upper edges of the first side wall (11) and the second side wall (12), and an orthodontic groove (14) jointly defined by the first side wall (11), the second side wall (12) and the dental crown upper wall (13). At least one of the dental crown upper wall (13), a first part connecting the dental crown upper wall (13) to the first side wall (11), and a second part connecting the dental crown upper wall (13) to the second side wall (12) has a thickness less than a thickness of the first side wall (11) and the second side wall (12).

In manufacturing the invisible plastic teeth brace (1) of the present invention, a patient could choose a solid dental model or a digital dental model. A process of the solid dental model comprises the steps of biting into a moulding material by the patient and using a gypsum to mold a solid dental model by the moulding material. A process of the digital dental model comprises the steps of using an intra-oral scanner to scan the patient's oral cavity so as to obtain the digital data of the patient's oral cavity and further construct the digital dental model by a computer on the basis of the digital data. Accordingly, the solid dental model or the digital dental model can be used to a software-designed orthodontic correction.

If the patient chooses the solid dental model for orthodontic correction, the solid dental model must first be placed inside a model scanner to obtain the digital data. A computer having a dental dentition simulation software is then used to carry out the automatic tooth arrangement and bite jamming simulation operations by the digital data of the solid dental model. Finally, the digital data from the initial stage to the final stage of the patient's invisible plastic teeth brace is generated.

If the patient chooses the digital dental model for orthodontic correction, a computer having a dental dentition simulation software is directly used to carry out the automatic tooth arrangement and bite jamming simulation operations by the digital data of the digital dental model and provide different thickness designs for the biting interference sites. Finally, the digital data from the initial stage to the final stage of the patient's invisible plastic teeth brace is also generated. After that, the digital data of the invisible plastic teeth brace is input into a 3D tooth carving machine or a CNC machine to manufacture the invisible plastic teeth brace having a different thickness.

When wearing the invisible plastic teeth brace (1), the patient's dental crowns (21) of the teeth (2) are covered by the orthodontic groove (14). In such a case, the first side wall (11) and the second side wall (12) respectively cover two laterals of the dental crowns (21), and the dental crown upper wall (13) covers a top surface of the dental crowns (21) so as to perform the dentition correction on the teeth (2), e.g. closing teeth gaps and the like, by the invisible plastic teeth brace (1).

When the patient wears the invisible plastic teeth brace (1) to bite and chew food by the upper and the lower teeth (2), the dental crown upper wall (13) covered on the top surface of the dental crowns (21) or the parts connecting the dental crown upper wall (13) to the first side wall (11) and the second side wall (12) of the invisible plastic teeth brace (1) are subject to an occlusal pressure. The design that the at least one of the dental crown upper wall (13), the first part connecting the dental crown upper wall (13) to the first side wall (11), and the second part connecting the dental crown upper wall (13) to the second side wall (12) have a thickness less than the thickness of the first side wall (11) and the second side wall (12) can effectively prevent dental pain and discomfort caused by the parts connecting the dental crown upper wall (13) to the two side walls (11) (12) subject to an occlusal pressure so as further to push the teeth (2).

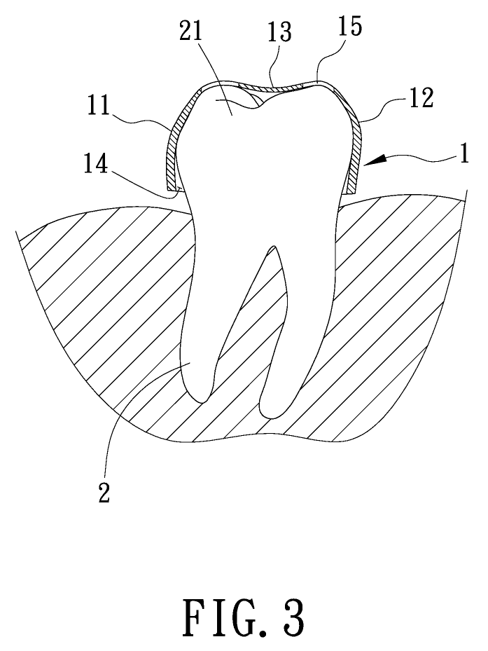

Referring to the FIG. 3, the present invention can also provide a perforation design for biting interference sites when the patient receives the software-designed orthodontic correction. In such a case, the invisible plastic teeth brace (1) is provided with at least one hole (15) on the dental crown upper wall (13) and/or on the parts connecting the dental crown upper wall (13) to the first side wall (11) and the second side wall (12). The at least one hole (15) is communicated with the orthodontic groove (14). Therefore, the design of the hole (15) on the parts connecting the dental crown upper wall (13) to the two side walls (11) (12) effectively prevent dental pain and discomfort caused by the parts subject to an occlusal pressure so as further to push the teeth (2).

What is claimed is:

1. An invisible plastic teeth brace for orthodontics, comprising:
a first side wall;
a second side wall opposite to the first side wall;
a dental crown upper wall for integrally connecting upper edges of the first side wall and the second side wall, wherein at least one of the dental crown upper wall, a first part connecting the dental crown upper wall to the first side wall, and a second part connecting the dental crown upper wall to the second side wall has a thickness less than a thickness of the first side wall and the second side wall; and
an orthodontic groove jointly defined by the first side wall, the second side wall and the dental crown upper wall.

2. The invisible plastic teeth brace for orthodontics as claimed in claim 1, wherein the dental crown upper wall is further provided with at least one hole for communicating with the orthodontic groove.

3. The invisible plastic teeth brace for orthodontics as claimed in claim 2, wherein at least one of the first part connecting the dental crown upper wall to the first side wall and the second part connecting the dental crown upper wall to the second side wall is provided with at least one hole for communicating with the orthodontic groove.

4. The invisible plastic teeth brace for orthodontics as claimed in claim 1, wherein at least one of the first part connecting the dental crown upper wall to the first side wall and the second part connecting the dental crown upper wall to the second side wall is provided with at least one hole for communicating with the orthodontic groove.

5. An invisible plastic teeth brace for orthodontics, comprising:
a first side wall;
a second side wall opposite to the first side wall;
a dental crown upper wall for integrally connecting upper edges of the first side wall and the second side wall, wherein at least one of the dental crown upper wall, a first part connecting the dental crown upper wall to the first side wall, and a second part connecting the dental crown upper wall to the second side wall has at least one hole; and
an orthodontic groove jointly defined by the first side wall, the second side wall and the dental crown upper wall and communicating with the at least one hole.
